(19) United States
(12) Patent Application Publication
(10) Pub. No.: US 2002/0026362 A1
(43) Pub. Date: Feb. 28, 2002

(54) Digital content creator/reproducer and advertisement distribution system

(75) Inventor: Kazuyoshi Tanaka, Tokyo (JP)

Correspondence Address: Paul J. Esatto, Jr., Scully, Scott, Murphy & Presser, 400 Garden City Plaza, Garden City, NY, 11530, US

(73) Assignee: NEC Corporation, Tokyo (JP)

(21) Appl. No.: 09/939,955

(22) Filed: Aug. 27, 2001

(30) Foreign Application Priority Data
Aug. 29, 2000 (JP) 2000-258405

(51) Int. Cl. G06F 17/60

(52) U.S. Cl. 705/14; 705/51

(57) ABSTRACT

A technique is provided of stimulating the spread of the electronic watermarking system, activating advertisement businesses over the Internet, and thus increasing advertisement incomes to the advertisement agency of an advertisement site. The system comprises a communication line, a digital content creator 702 and an advertisement site 704 interconnected by said communication line, and a digital content reproducer 706. The digital content creator 702 inserts electronic watermarked data representing the URL of the advertisement site into a digital content. The digital content reproducer 706 extracts electronic watermarked data, accesses the advertisement site based on the value, and reads out the advertisement information. The digital content reproducer 706 manifests the digital content and the advertisement information.

### BACKGROUND OF THE INVENTION

The present invention relates to an advertisement distribution system using networks. Particularly, the present invention relates to a system for inserting identification data (electronic watermark data) with special information into a digital content and then distributing a desired advertisement to browsers of the digital content through a network.

Recently, contents have been digitized vigorously. It will be true that an explosive increase of WWW users over the Internet as well as the spread of the hardware that can use large capacity data at personal level have quickly accelerated the digitization of contents. With the digitization of contents accelerated, illegal copies of digital contents have caused a serious social problem. The technique of inserting and detecting electronic watermarked data is noted as a technique of blocking the illegal copies and is being now studied toward practical use. The electronic watermarking technique is a technique of burying ID information, as a kind of noise, being difficult for men to recognize but being machine readable, in the data itself of a digital content. The buried information always is in presence together with the digital content and cannot be easily erased and changed. Using those features, the electronic watermarking technique aims at preventing digital contents from being illegally copied.

As described above, the original object of the electronic watermarking technique is to prevent digital contents from being illegally copied. In other words, the electronic watermarked data is utilized for the copyright protection and hence is restricted in usage. Broader diffusion of the electronic watermarking technique has been intended by expanding uses of the electronic watermarked data.

In contrast, the wide spread of the Internet has stimulated the business in which an advertisement agency gains earnings from advertisements placed on a home page. For example, among some of the so-called portal sites, there are advertisement sites that are being successfully run with advertisement earnings. Hence, the maximum concern of the advertisement agency having advertisement sites is how the access count to their advertisement sites is increased. The reason is that an increase in access count to an advertisement site in open enhances the reputation therefor so that an increased number of companies wanting advertisements to be placed on the site leads to an increase of earnings of the advertisement agency.

### SUMMARY OF THE INVENTION

The present invention is made to solve the above-mentioned problems. An objective of the present invention to provide a technique of technically combining a business that supplies digital contents including electronic watermarked data with an advertisement business on the Internet. Thus, this technique stimulates the spread of the electronic watermarking technique, activates advertisement businesses over the Internet and increases advertisement incomes to the advertisement agency of an advertisement site.

In order to achieve the above object, the URL of an advertisement site is inserted into electronic watermarked data. Thus, the mechanism that the user, who views the digital content containing the electronic watermarked data, accesses a predetermined advertisement site is provided. For that reason, the present invention relates to the digital content creator, a digital content reproducer, and an advertisement information distribution system in which them are combined with the Internet. The features of these devices and the system are as follows:

The digital content creator of the present invention features that electronic watermarked data, in which the URL of a Web site supplying advertisement information is described, is inserted into a digital content.

Moreover, according to the present invention, the digital content reproducer detects electronic watermarked data from a digital content containing the electronic watermarked data while manifests the digital content on the display. The feature is that the Web site supplying advertisement information is accessed based on the value of the electronic watermarked data and the advertisement information is manifested on the display.

Moreover, the advertisement information distribution system includes a communication line as well as a digital content reproducer, an advertisement site, and a digital content creator, interconnected to the communication line. The digital content creator has an inserter for inserting electronic watermarked data into a digital content. The digital content reproducer includes means for detecting electronic watermarked data from a digital content containing the electronic watermarked data, means for reading advertisement information from an advertisement site specified with the electronic watermarked data value, and means for displaying the reproduced digital content and the advertisement information. The advertisement site includes means for distributing goods or services.

An example of the electronic watermark insertion and detection technique will be explained below for reference. However, the present invention should not be limited to the example only but can be realized using other electronic watermark insertion and detection technique.

The method of frequency-converting an image and then burying electronic watermarked data in an area with a strong frequency component of a video signal after the frequency conversion has been proposed as an example of an electronic watermarking technique (refer to NIKKEI Electronics. Apr. 22, 1996, (no. 660), page. 13). In this method, since the electronic watermarked data is buried in the strong frequency component, a loss of the electronic watermarked data does not occur even if it is subjected to a compression/expansion process or imaging such as filtering. The electronic watermarked data cannot be removed if the original image is not destroyed. Moreover, using random numbers obeying a normal distribution as electronic watermarked data prevents interference between sets of electronic watermarked data. As a result, the method can prevent a decrease in image quality due to the burying of electronic watermarked data.

In the electronic watermarked data burying method, an original image is converted into frequency components using the DCT (discrete cosine conversion). N sets of data having high values over the frequency region are selected as f(1), f(2), . . . f(n). Sets of electronic watermarked data w(1), w(2), . . . w(n) are selected from a normal distribution which has the average value of 0 and the distribution value of 1. The following formula is calculated in terms of i.

F(i)=f(i)+α×|f(i)|×w(i)

where α is a scaling factor.

The image in which electronic watermarked data is buried can be obtained by subjecting F(i) to inverse DCT conversion.

The electronic watermarked data is detected in the following way. In this detection method, the original image f(i) and electronic watermarked data candidate w(i) (where i=1, 2, . . . , n) have to be known.

The electronic-watermarked-data inserted image is converted into a frequency component using the DCT. Values of factors f(1), f(2), . . . , f(n), into which electronic watermarked data is buried over the frequency region, correspond to F(1), F(2), . . . , F(n), respectively. The electronic watermarked data W(i) is calculated and extracted in accordance with the following formula.

W(i)=(F(i)−f(i))/f(i)

Next, the statistical similarity of w(i) and W(i) is calculated using the inner product of vectors and the following formula.

C=W·w/(WD×wD)

Where

W=(W(1), W(2), . . . , W(n),

w=(w(1), w(2), . . . , w(n),

WD=an absolute value of a vector W, wD=an absolute value of a vector w, and · is an inner product of a vector.

When the statistical similarity C exceeds a specific value, it is judged that the corresponding electronic watermarked data is in a buried state.

The above method in which electronic watermarked data is buried in an image is effective when a copyright owner of the original image detects digital image data suspected of being an illegal copy. In this method, since the original image is required, the copyright owner can detect the electronic watermarked data buried in the illegal image data. However, the reproducer at each terminal cannot detect the electronic watermarked data because of no possession of the original image.

For that reason, an improvement of the method has been proposed. In the improved method, the original image is divided into blocks each having 8 pixels×8 pixels. The electronic watermarked data is buried and extracted in processing units of each block.

In the electronic watermarked data burying process, it is assumed that f(1), f(2), . . . , f(n) are arranged in the frequency increasing order of AC components in a frequency region after completion of DCT. The electronic watermarked data w(1), w(2), . . . , w(n) are first selected from the normal distribution with an average value of 0 and a dispersion value of 1. Each i is calculated by the following formula.

F(i)=f(i)+α×avg(f(i))×w(i)

where α is a scaling factor, and avg(f(i)) is a partial average obtained by averaging absolute values of adjacent three points.

The electronic watermarked data is detected in accordance with the following method. In this detection method, the original image is not required but the electronic watermarked data candidate w(i) (where i=1, 2, . . . , n) has to be known.

An image in which electronic watermarked data is buried can be obtained by subjecting F(i) to inverse DCT conversion.

The electronic watermarked data is detected in the following method.

An image in which electronic watermarked data is buried is subjected to DCT conversion. F(1), F(2), . . . , F(n) are arranged in the frequency-component increasing order over the frequency region in each block. The average value of the absolute values at adjacent three points, F(i−1), F(i), F(i+1), of F(i) is assumed to be a partial average avg(F(i)). The electronic watermarked data W(i) is calculated with the formula, W(i)=F(i)/avg(F(i)). The sum WF(i) of W(i) for one image is calculated for each (i).

Next, the statistical similarity of w(i) and WF(i) is calculated using the vector inner product and the following formula.

C=WF·w/(WFD×wD)

When the statistical similarity C exceeds a specific value, it is judged that the corresponding watermarked data is in a buried state.

### BRIEF DESCRIPTION OF THE DRAWINGS

This and other objects, features and advantages of the present invention will become more apparent upon a reading of the following detailed description and drawings, in which,

FIG. 1 is a block diagram illustrating a digital content creator according to an embodiment of the present invention;

FIG. 2 is a flowchart illustrating of a digital content creation method according to an embodiment of the present invention;

FIG. 3 is a block diagram illustrating a recording medium according to an embodiment of the present invention;

FIG. 4 is a block diagram illustrating the digital content creator according to the embodiment of the present invention;

FIG. 5 is a block diagram illustrating the digital content creator according to the embodiment of the present invention;

FIG. 6 is a block diagram illustrating a recording medium according to an embodiment of the present invention; and

FIG. 7 is a block diagram illustrating an advertisement information distribution system according to an embodiment of the present invention.

### DESCRIPTION OF THE EMBODIMENTS

A digital content creator according to an embodiment of the present invention will be described below by referring to the attached drawings.

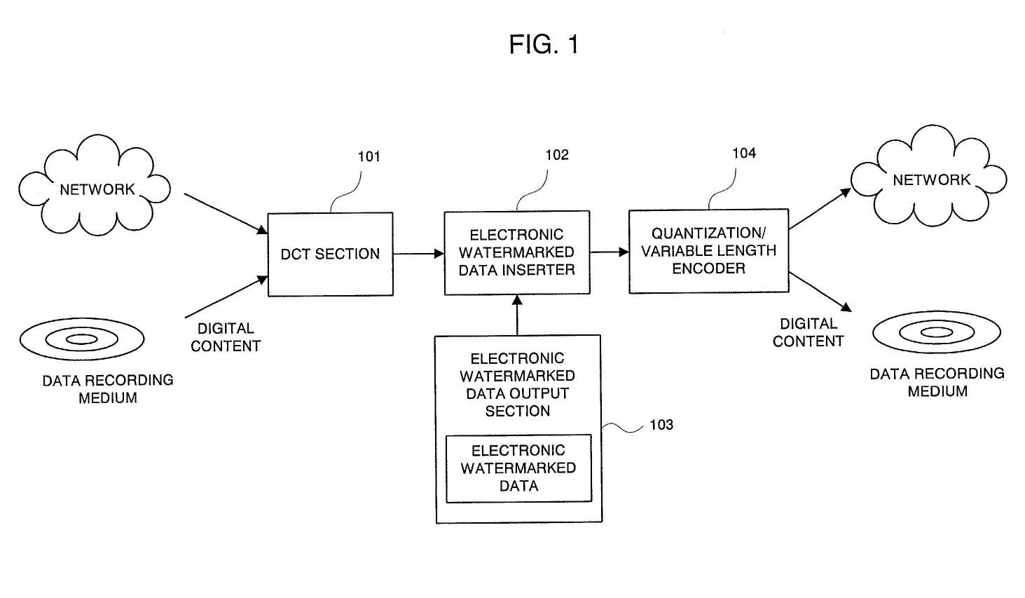

FIG. 1 is a block diagram illustrating the configuration of a digital content creator.

The digital content creator inserts electronic watermarked data which includes the URL of a Web site originating advertisement information, into a digital content (still images, moving images, and audio). The digital content is supplied through a disk recording medium such as DVD, CD-ROM, and the like or through a data recording medium, such as a semiconductor media, that can treat multi-media data, or through a network.

Referring to FIG. 1, the digital content creator includes a DCT (discrete cosine conversion) section 100, an electronic watermarked data output section 103 that stores electronic watermarked data, an electronic watermarked data inserter 102, and a quantization/variable length encoder 104. The DCT is shown as an example of means for spectrum converting a digital content as a still image or moving image. Other converters may be used as the DCT.

Respective constituent elements are realized by an information processing device and a memory device, mounted on a personal computer, on a workstation, or on other computer system. The information processing device, which includes an internal memory for storing data, a signal input port, and a signal output port, executes processing according to a control program. The signal input port may receive digital contents. The signal output port may a digital content containing an electronic watermark. The control program is stored onto a magnetic disk, semiconductor memory, or other recording medium and is loaded to the information processing device. The recording medium may be a medium readable by the information processing device and is not limited by the type thereof.

In response to a digital content issued from a digital content owner (e.g. a copyright owner) via a network or via a data recording medium, the DCT section 101 subjects it to discrete cosine conversion and then outputs a frequency component signals to the electronic watermarked data inserter 102. The electronic watermarked data output section 103 previously stores as electronic watermarked data the URL of a Web site supplying advertisement information. The electronic watermarked data inserter 102 receives a frequency component signal from the DCT section 101 and electronic watermarked data output from the electronic watermarked output section 103 and inserts the electronic watermarked data into the frequency component signal. The quantization/variable length encoder 104 subjects the electronic watermarked frequency component signal to quantification and variable-length encoding and then outputs the encoded signal to the network or to data recording medium. In other words, using the information compression technique of MPEG (Motion Picture Experts Group), the quantization/variable length encoder 104 outputs the MPEG stream to the communication medium, broadcasting medium, or storage medium.

In this embodiment, the URL itself is inserted as electronic watermarked data. When there is a table for representing the URL with a predetermined index value on the side of the electronic watermarked data extraction device, the index value may be inserted as electronic watermarked data. In this case, the data structure that electronic watermarked data itself may have an index value and the data structure that the bit group of part of electronic watermarked data may have an index value.

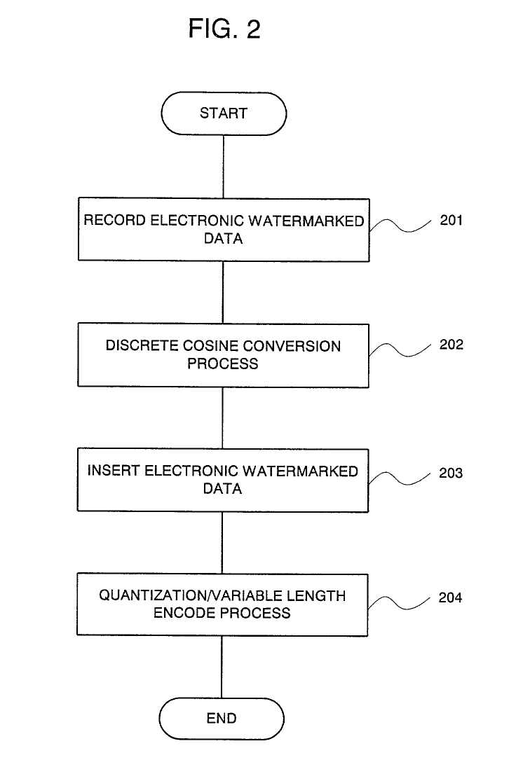

Next, the operation of the present embodiment will be described by referring to FIG. 2. When the digital content creator is realized by a computer system, the control program that controls the information processing device includes an instruction that makes the information processing device execute respective steps (to be explained below). Thus, the control program makes the information processing device execute the process of inserting electronic watermarked data into the digital content to be input from the signal input port.

First, the memory in the electronic watermarked data output section stores as electronic watermarked data the URL of a Web site generating advertisement information (step 201).

Next, after a digital content is input to the signal input port, the DCT section 101 subjects the input digital content to discrete cosine conversion (step 202). This step may be the process of converting the digital content into a frequency component through the spectrum conversion. The step does not care about the content.

Next, the electronic watermarked data inserter 102 inserts the electronic watermarked data issued from the electronic watermarked data output 103 into the data spectrum-converted by the DCT section 101 (step 203).

Thereafter, the quantization/variable length encoder 104 quantizes and variable-length encodes the electronic watermarked frequency component signal output from the electronic watermarked data inserter 102 and outputs the electronic watermarked digital content (step 204).

The electronic watermarked digital content thus created is supplied or displayed to users at cost or at no charge through the data recording medium or though the network (a communication system or broadcasting system).

This embodiment employs the system of burying electronic watermarked data into the frequency region after spectrum conversion. However, other system of burying electronic watermarked data in pixel data may be used as the electronic watermarked data insertion system. Moreover, the present embodiment does not care about the types of contents. However, when the digital content relates to an advertisement image regarding goods or services, how the detail information about goods represented with the advertisement image is available from the Web site can be provided. Moreover, how the goods are available from the Web site can be provided. This enables development to the Internet shopping.

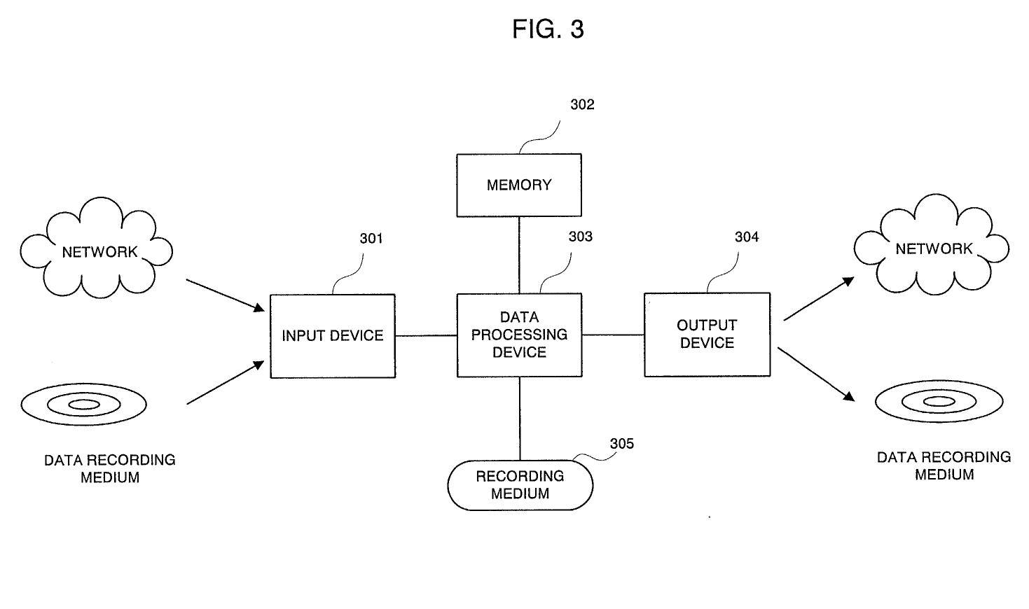

Next, the embodiment of a recording medium according to the present invention will be described by referring to FIG. 3.

Referring to FIG. 3, the embodiment includes a recording medium 305 that records an electronic watermarked insertion program. The recording medium is a magnetic disk, a semiconductor memory, or the like. The electronic watermark insertion program, which is read in from the recording medium 305 to the data processing device 303, controls the operation of the data processing device. Under control of the electronic watermark insertion program, the data processing device 303 executes the same process as that in the previous embodiment. That is, the input device 301 receives a digital content from the network or from the data recording medium and then outputs it to the data processing device 303. The data processing device 303 inserts electronic watermarked data into the digital content and outputs the inserted data to the output device 304. The output device 304 outputs the digital content containing the electronic watermarked data to the network (in a communication system or broadcasting system) or to the data recording medium.

Next, the digital content reproducer according to the embodiment of the present invention will be described by referring to the drawings.

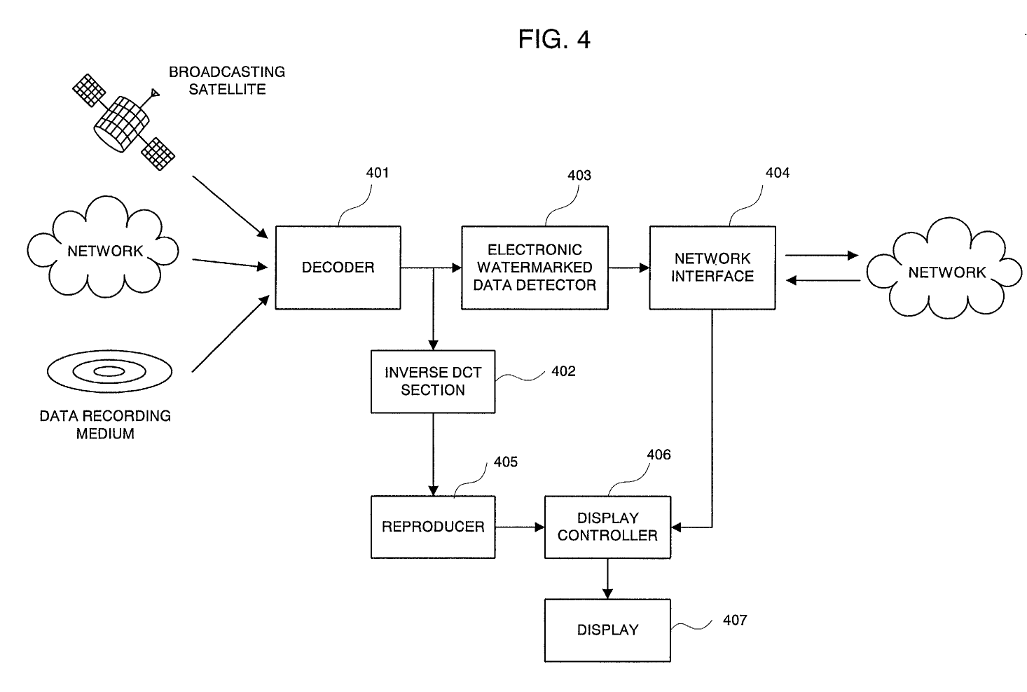

FIG. 4 is a block diagram illustrating the configuration of a digital content reproducer.

The digital content reproducer extracts electronic watermarked data from among a digital content, for example, a still image or moving image, supplied or displayed through the data recording medium or though the network (in the communication system or broadcasting system), accesses the Web site issuing advertisement information based on the value of the extracted data, and then manifests the advertisement information on the display.

Referring to FIG. 4, the digital content reproducer includes a decoder 401, an inverse DCT section 402, an electronic watermarked data detector 403, a network interface 404, a reproducer 405, a display controller 406, and a display 407. The digital content reproducer is connected to the Internet. In the digital content reproducer, including a WWW Browser installed thereto, is set so as to operate it.

Respective constituent elements are realized on the information processing device, the memory, and the display, mounted on a personal computer, workstation, or other computer system. The information processing device, which has an internal memory for storing data, a signal input port, and a signal output port, executes processing in accordance with the control program. The signal input port may receive electronic watermarked digital contents. The signal output port may output the URL based on a digital content and based on detected electronic watermarked data. The control program is stored in a magnetic disk, a semiconductor memory, or other recording medium and then is loaded to the information processing device. The recording medium may be one that can be read by the information processing device and the format thereof is not limited. In response to the URL output from the signal output port, the network interface accesses the Web site represented by the URL and thus reads out advertisement information. The display manifests a digital content and the advertisement information thereof.

In the above configuration, the decoder 401 receives an electronic watermarked digital content (e.g. a content in a MPEG stream format) from the network (in a communication system or broadcasting system) or from the recording medium and then extracts the DCT coefficient. The electronic watermarked data detector 403 receives the DCT coefficient from the decoder 401, detects the electronic watermarked data from the DCT coefficient, and then outputs it to the network interface 404. Since the electronic watermarked data contains the URL of the web site, the network interface 404 accesses the web site shown by the URL, reads out the advertisement information, and then outputs it to the display controller 406. The web site corresponds to an advertisement site providing advertisement information. The inverse DCT section 402 subjects the DCT coefficient sent from the decoder 401 to inverse discrete cosine conversion and outputs the converted data to the reproducer 405. The reproducer 405 reproduces the digital content and then outputs it to display controller 406. The display controller 406 manifests the advertisement information and the digital content on the display 407.

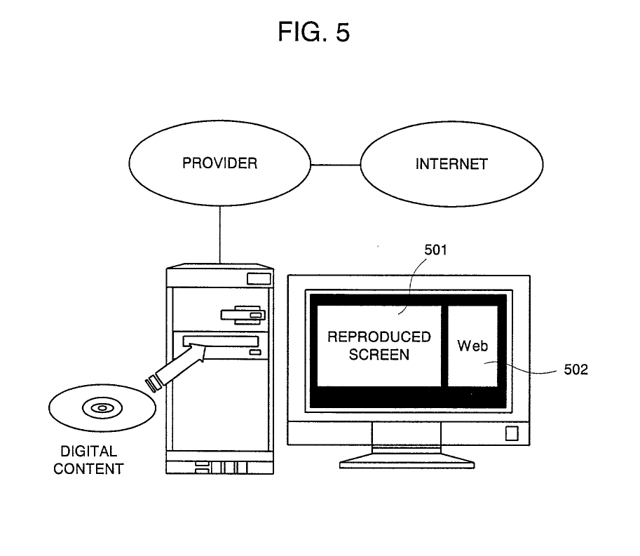

FIG. 5 shows an example of an image displayed on the display. Numeral 501 represents the screen displaying a reproduced digital component. Numeral 502 represents the screen displaying a home page of an accessed Web site. For example, when a digital content is an advertisement image regarding goods or services, the advertisement image and the advertisement information are divisionally displayed on the display. Thus, the viewer can obtain detailed information about the goods while seeing the advertisement image. In order to buy the goods, the viewer can continuously do the Internet shopping at the web site.

The present embodiment employs the electronic watermark extraction system, paired with the electronic watermark insertion system that buries electronic watermarked data in frequency regions after spectrum conversion. However, the extraction system that is paired with the system of burying electronic watermarked data in pixel data may be used in the present embodiment. That is, the type of electronic watermark extraction system is not the essence of the present invention. The present embodiment does not care about the type of digital content.

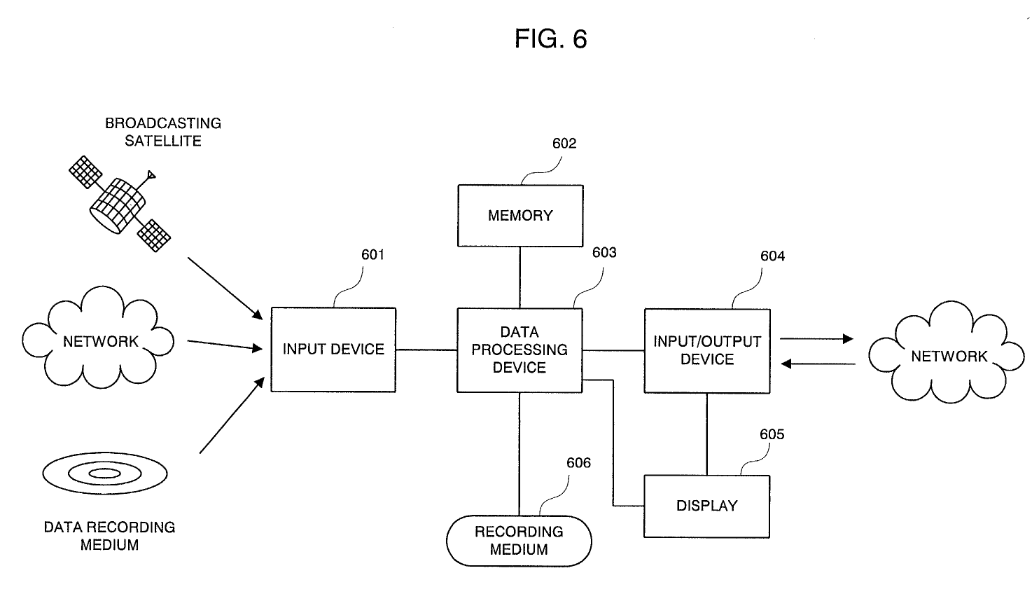

Next, the recording medium according to an embodiment of the present invention will be described below by referring to FIG. 6.

Referring to FIG. 6, the embodiment includes a recording medium 606 on which a program having an electronic watermark extraction function and an internet access function is recorded. The recording medium 606 is a magnetic disk, a semiconductor memory, or the like. The electronic watermark insertion program is read in from the recording medium 606 to the data processing device and then controls the operation of the data processing device 603. Under control of the electronic watermarked insertion program, the data processing device 603 implements the same process as that in the previous embodiment. The data processing device executes the process of reproducing digital contents.

In other words, the input device 601 receives a digital content from the network (in a communication system or broadcasting system) or through the data recording medium and then outputs it to the data processing device 603. Under control of the program stored in the recording medium 606, the data processing device 603 extracts the electronic watermarked data from the digital content and then outputs it to the input/output device 604. The input/output device 604 accesses the Web site based on the data and acquires the advertisement information. The display 605 receives the digital content and the advertisement information from the data processing device 603 and the input/output device 604 and then displays them.

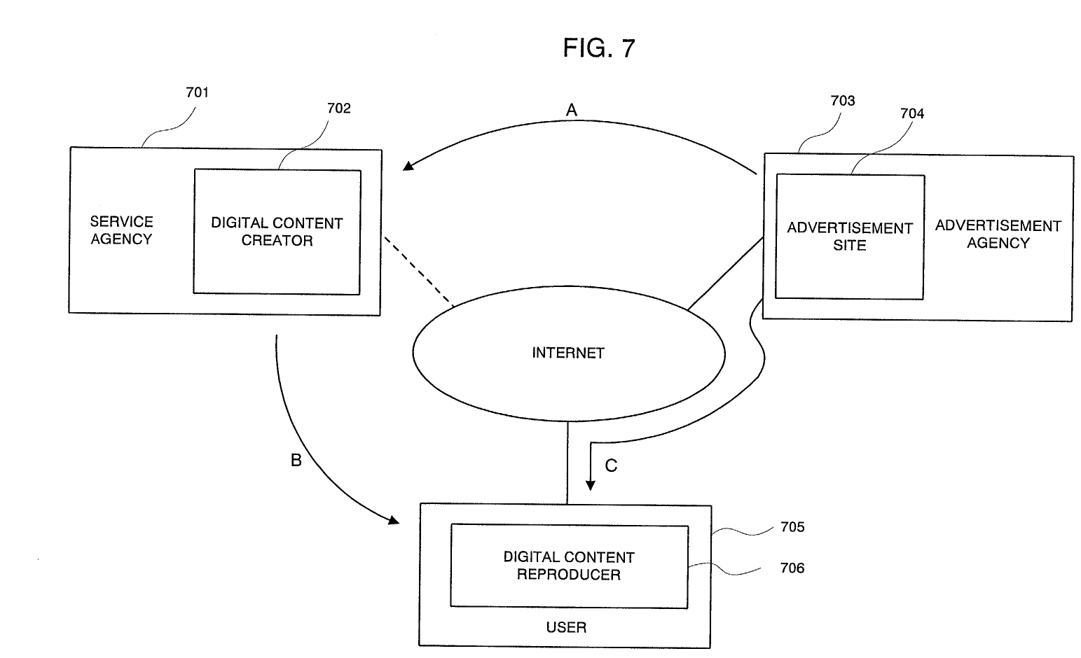

Next, the advertisement information distribution system according to an embodiment of the present invention will be described below by referring to FIG. 7. This system consists of a digital content creator 702, held by a service agency 701 which inserts electronic watermarked data into a digital content, a digital content reproducer 706, held by a user 705 which reproduces a digital content, and a Web site 704, held by an advertisement agency 703 which issues advertisement information onto the Internet.

The digital content creator 702 inserts electronic watermarked data (the URL of the advertisement site 704) into a digital content such as a still image or a moving image and then supplies it to users. The digital content is often provided through a communication network (e.g. the Internet), a broadcasting network (e.g. satellite broadcasting), or a data recording medium. The specific configuration has been already described in the previous embodiments.

The digital content reproducer 706 reproduces an electronic watermarked digital content and manifests it on the display. Furthermore, the digital content reproducer 706 extracts the electronic watermarked data from the digital content, accesses the Web site 704 supplying advertisement information based on the value thereof, acquires the advertisement information, and then manifests it on the display. The specific configuration has been described in the previous embodiment.

Next, the whole operation and effect will be explained below in the example where the digital content is an advertisement image.

The advertisement agency 703 creates a digital content for an advertisement image. The completed digital content is provided to a service agency which inserts electronic watermarked data (A). The electronic watermarked data to be inserted is the URL of a Web site of the advertisement agency opened over the Internet. Thereafter, the service agency 701 supplies the digital content with the electronic watermarked data to the user 705 at cost or at no charge (B). Using the digital content reproducer 706, the user 705 reproduces the digital content and views the advertisement image. The digital content reproducer 706 reads out the detailed advertisement information from the Web site 704 of the advertisement agency and then displays it to the user 706 (C).

The above configuration allows the user 705 to see simultaneously both the advertisement image and the detailed advertisement information. Thus, the user 705 can obtain a detailed knowledge of items regarding the advertisement. The advertisement agency 703 can enhance the effect of the advertisement and can estimate an increase in advertisement income. This feature allows the service agent of inserting the electronic watermarked data to gain profits (commission).

According to the present invention, the business providing digital contents into which electronic watermarked data is inserted is technically combined with the advertisement business performed over the Internet. Thus, this feature enables spreading the electronic watermarking technique, activating the advertisement business over the Internet, and increasing the advertisement incomes of an advertisement agency having an advertisement site.

The entire disclosure of Japanese Patent Application No. 2000-258405 filed on Aug. 29, 2000 including specification, claims, drawings and summary are incorporated herein by reference in its entirety.

What is claimed is:

1. A digital content creator for inserting electronic watermarked data into a digital content, said electronic watermarked data in which a URL (Uniform Resource Locator) of a Web site providing advertisement information is described.

2. The digital content creator defined in claim 1, wherein said digital content comprises an advertisement image.

3. A digital content creator comprising:
a discrete cosine converter for subjecting a digital content to discrete cosine conversion and thus creating a DCT coefficient; and
a data inserter for inserting electronic watermarked data into said DCT coefficient;
said electronic watermarked data in which a URL (Uniform Resource Locator) of a Web site providing advertisement information is described.

4. The digital content creator defined in claim 2, wherein said digital content comprises an advertisement image.

5. A digital content creator for inserting electronic watermarked data into a digital content, said electronic watermarked data in which a URL (Uniform Resource Locator) of a Web site providing advertisement information is described, said digital content creator comprising:
an inserter for inserting said electronic watermarked data into said digital content.

6. The digital content reproducer defined in claim 5, wherein said digital content comprises an advertisement image.

7. A digital content creator comprising:
a discrete cosine converter for subjecting a digital content to discrete cosine conversion and thus creating a DCT coefficient; and
a data inserter for inserting electronic watermarked data into said DCT coefficient;
said electronic watermarked data in which a URL (Uniform Resource Locator) of a Web site providing advertisement information is described; and
an inserter for inserting said electronic watermarked data into said digital content.

8. The digital content reproducer defined in claim 7, wherein said digital content comprises an advertisement image.

9. A digital content reproducer that detects electronic watermarked data inserted in a digital content and then manifests said digital content on a display, wherein a Web site supplying advertisement information is accessed based on a value of said electronic watermarked data to receive said advertisement information, said advertisement information being manifested on said display.

10. The digital content reproducer defined in claim 9, wherein said digital content comprises an advertisement image.

11. A digital content reproducer comprising:
a decoder for extracting a DCT coefficient from a digital content into which electronic watermarked data is inserted;
a detector for detecting said electronic watermarked data inserted into said DCT coefficient; and
a display for subjecting said DCT coefficient to inverse discrete conversion and reproducing said digital content;
wherein said display receives said advertisement information by accessing a Web site supplying advertisement information based on said electronic watermarked data and manifests said advertisement information on said display.

12. The digital content reproducer defined in claim 11, wherein said digital content comprises an advertisement image.

13. An advertisement information distribution system comprising:
a communication line;
a digital content reproducer and an advertisement site which are interconnected to said communication line; and
a digital content creator;
said digital content creator having means for inserting electronic watermarked data into a digital content;
said digital content reproducer having means for detecting electronic watermarked data from a digital content into which electronic watermarked data is inserted; means for reading out advertisement information from an advertisement site specified by a value of electronic watermarked data through said communication line; means for reproducing digital contents; and means for displaying a reproduced digital content and said advertisement information;
said advertisement site having means for distributing goods or services.

14. The advertisement information distribution system defined in claim 13, wherein said communication line comprises the Internet.

15. The advertisement information distribution system defined in claim 14, wherein a URL of a Web site supplying advertisement information is described to said electronic watermarked data.

16. The advertisement information distribution system defined in claim 13, wherein said digital content comprises an advertisement image.

17. A digital content creation method wherein electronic watermarked data is inserted into a digital content, said electronic watermarked data in which a URL of a Web site supplying advertisement information is described.

18. The digital content creation method defined in claim 17, wherein said digital content comprises an advertisement image.

19. A digital content creation method comprising the steps of:
creating a DCT coefficient by subjecting a digital content to discrete cosine conversion; and
inserting electronic watermarked data into said DCT coefficient;
said electronic watermarked data in which a URL of a Web site supplying advertisement information is described.

20. The digital content creation method defined in claim 19, wherein said digital content comprises an advertisement image.

21. A digital content reproduction method, wherein electronic watermarked data inserted into a digital content is detected and said digital content is manifested on a display, comprising the steps of:
receiving said advertisement information by accessing a Web site supplying advertisement information based on a value of said electronic watermarked data; and
manifesting said advertisement information on said display.

22. The digital content reproduction method defined in claim 21, wherein said digital content comprises an advertisement image.

23. A digital content reproduction method comprising the steps of:
extracting a DCT coefficient from a digital content into which electronic watermarked data is inserted;
detecting said electronic watermarked data inserted into said DCT coefficient;
subjecting said DCT coefficient to inverse discrete cosine conversion and then reproducing said digital content;
displaying said reproduced digital content;
receiving said advertisement information by accessing a Web site supplying advertisement information based on a value of said electronic watermarked data; and
displaying said advertisement information.

24. The digital content reproduction method defined in claim 23, wherein said digital content comprises an advertisement image.

25. An advertisement information distribution method comprising the steps of:
inserting electronic watermarked data into a digital content;
outputting the digital content into which said electronic watermarked data is inserted;
extracting electronic watermarked data from the digital content into which said electronic watermarked data is inserted;
reading out the advertisement information from a Web site specified by a value of said electronic watermarked data; and
displaying said digital content and said advertisement information.

26. The advertisement information distribution method defined in claim 25, wherein a URL of said Web site supplying advertisement information is described to said electronic watermarked data.

27. The advertisement information distribution method defined in claim 25, wherein said digital content comprises an advertisement image.

28. A computer readable recording medium on which a program is recorded, said program making a computer execute the step of creating a DCT coefficient by discrete-cosine converting a digital content and the step of inserting electronic watermarked data into said DCT coefficient;
an URL of a Web site supplying advertisement information being described to said electronic watermarked data.

29. The recording medium defined in claim 28, wherein said digital content comprises an advertisement image.

30. A computer readable recording medium on which a program is recorded, said program making a computer execute the step of extracting a DCT coefficient from a digital content into which electronic watermarked data is inserted, the step of detecting said electronic watermarked data inserted into said DCT coefficient, the step of inverse-discrete-cosine converting said DCT coefficient to reproduce a digital content, and the step of displaying the reproduced digital content, said computer storing a program for executing the steps of receiving said advertisement information by accessing the web site based on a value of said electronic watermarked data and displaying said advertisement information.

31. The recording medium defined in claim 30, wherein said digital content comprises an advertisement image.
